(19) United States
(12) Patent Application Publication
(10) Pub. No.: US 2021/0205162 A1
(43) Pub. Date: Jul. 8, 2021

(54) SURGICAL POSITIONER APPARATUS, SYSTEM, AND METHOD FOR SECURING TO A SIDE RAIL OF SUPPORT TABLE

(71) Applicant: INNOVATIVE MEDICAL PRODUCTS, INC., Plainville, CT (US)

(72) Inventor: Tamas KOVACS, Burlington, CT (US)

(21) Appl. No.: 17/073,349

(22) Filed: Oct. 17, 2020

Related U.S. Application Data
(60) Provisional application No. 62/916,796, filed on Oct. 17, 2019.

(51) Int. Cl. A61G 13/00; A61G 13/10; A61G 13/12

(52) U.S. Cl. CPC A61G 13/0081; A61G 13/101; A61G 13/129; A61G 13/1245; A61G 13/125

(57) ABSTRACT

A surgical positioner system for a support table having a side rail having a clamp assembly for attaching to the side rail. The clamp assembly having a spring and a locking assembly with movement in the x- and y-plane; and extension provides sliding movement in the z-plane. The extension being dimensioned to be operably connected to said clamp assembly and a rotational assembly. A rotational assembly has a portion for operably connecting to the extension, a device attachment portion, and a rotational assembly operably connected to the device attachment portion for providing rotational thereof. A boot having a holder portion and a flexible attachment can be attached to the device attachment portion. The surgical positioner provides motion from different force factors causing multiple components to move in a coordinated way using such established pivots and useful in performing various surgical procedures including direct anterior approach total hip replacement surgery.

### CROSS REFERENCE TO RELATED APPLICATIONS

This application claims the benefit of U.S. Provisional Application No. 62/916,796, filed Oct. 17, 2019, which is incorporated entirely.

### FIELD OF THE INVENTION

The present invention relates to surgical positioners for hip replacement procedures and, more particularly, to an improved surgical positioner connectable to the side rail of a surgical support table facilitating bilateral surgeries and is useful for direct anterior approach total hip replacement surgery and other orthopedic surgical procedures.

### BACKGROUND OF THE INVENTION

Conventional hip replacement surgeries position the patient to access the surgical site. The anterior approach or direct anterior approach (DAA) provides the least disruptive surgical approach but is more technically demanding from a surgeon's perspective because of the need for increased awareness of the local anatomy, reduced visibility, and the use of smaller incisions. In this approach, the incision in the abdomen extends to the patient's thigh and is carried down to the tensor fasciae, the fasciae is split in the interval between the tensor fasciae latae and the satorius muscle, and then the space between the rectus femoris and the gluteus medius muscles is opened without having to cut across any muscles accessing the hip joint itself, thereby preserving the muscle attachments. The present invention provides a surgical positioner optimized for attachment to side rails of the support table to accomplish a minimally invasive direct anterolateral approach that is not available in the marketplace.

The less invasive direct anterior approach is a surgical technique performed through a short skin incision to avoid injury to muscles and tendons in a total hip replacement surgery, with advantages including less damage to tissue and muscle, smaller scars, less blood loss during surgery, less postoperative pain, and shorter hospital stays and convalescence. Consequently, there is a need for a surgical positioner for the direct anterior approach to provide the surgeon with improved access to the surgical site, providing greater respect for soft tissues, sparing of the muscles and tendons, and less trauma to the patient from the use of sandbags, positioning the leg off of the table and other problems associated with known surgical positioners.

Conventional surgical positioners for the direct anterior approach generally utilize specialized support tables having extensions that position, hold, and manipulate the limbs of the patient during the surgical procedure. These support tables are expensive, and the components heavy and difficult to sterilize. In addition, hip positioning systems utilize a perineal post that to can cause injury to muscles and tendons as well as contribute to postoperative pain and increased convalescence in a total hip replacement surgery. Moreover, conventional DAA positioning systems require additional mobile support devices for rotation around a rotational axis perpendicular to an axis formed by the post, which corresponds to the external rotation of a lower limb of a patient, when the patient's foot is received in an orthopedic boot. Rotational movement of the leg is accomplished by this separate mobile support apparatus secured to the floor and positioned relative to the support table. A mobile support in conjunction with the support table requires additional space, expensive, and support set up time in connection with a total hip replacement surgical procedure. Furthermore, alignment of the patient's leg relative to the support table is accomplished by line of sight, and attaching the bar extending from the table to the separate rotational apparatus. There is a need for a positioning system that attaches to existing support tables that maintains the position of the patient in line with the support table that provides all degrees of manipulation of the patient's leg such as, for example lateral (e.g., x-plane), vertical (y-plane) and forward/backward (z-plane) along with rotational movement of the patient's limb.

Conventional surgical positioners for the direct anterior approach are more technically demanding from a surgeon's perspective because the opposite leg is held and manipulated with increased demands for larger limbs and weight. Conventional hip systems have attachment arms that are heavy and provide challenges for surgeons when operating on larger limbs due to the weight. Moreover, the sterile field may be breached by dropping the leg below the support table for manipulating the joint when releasing the ball of the hip from the socket. The attachment arms to the support table that support the patient limbs typically involve lowering the leg for manipulation below the sterile field defined by the plane of the support table for manipulation by the surgeon in the outer rotation, hyperextension and forced adduction and/or dislocation. There is a need for a hip positioning system that attaches to existing support tables having a simple design with few components to set up, that achieves all necessary positions to perform hip surgery, all while remaining within the sterile field.

There is a need for a hip positioning system where no communication with an assistant is necessary to manipulate the patient's limb, and all detailed maneuvering is done directly by the surgeon in the sterile field, where no interpretation of minute finite or gross adjustments to a non-sterile assistant is required.

There is a need for a hip positioning system where all adjustments are handled through just four mechanical methods: levers, knobs, buttons or handles. These four methods to achieve abduction, adduction, internal and external rotation, traction, raising and lowering of the limb, as well as complete rotation, to accommodate all areas of movement to complete an anterior hip replacement. This system would allow the surgeon to control traction, distraction, rotation and dislocation without the need for an assistant that is out of the sterile field.

There is a need for a hip positioning system that minimizes the set-up time as it relates to attachment to the support table side rails that does not require independent free-standing towers, mobile supports, and/or heavy extensions.

There is a need for a positioning system that minimizes storage space, as the components can be stored in one or two cases without the space required by an independent platform or removable arms that are heavy, lengthy, and require at least two people to set up and prepare for surgery.

There is a need for a hip positioning system that is easily sterilizable and performs the hip procedure in and above the sterilized field.

There is a need for a hip positioning system that doesn't require a perineal post that can cause injury to muscles and tendons as well as contribute to postoperative pain and increased convalescence in a total hip replacement surgery.

### SUMMARY OF THE INVENTION

The hip positioning system advantageously provides superior surgical access to the patient during a surgical procedure.

The hip positioning system is configured to work advantageously with a standard support table by attaching to the side rail thereof.

The hip positioning system is configured to provide freedom of movement to the patient and surgeon.

The hip positioning system is configured as a bilateral clamp for use with clamping to either side rail of an existing support table.

The hip positioning system is configured for full rotational movement, and a conical range of motion that achieves pivoting in a range of 360 degrees, 180 degrees in the vertical and 180 degrees in the horizontal.

The hip positioning system is configured for movement of 180 degrees, e.g., left to right (medial to lateral relative to the patient), or lateral movement in the x-plane.

The hip positioning system is configured for movement of 180 degrees, e.g., up/down or vertical (raising and/lowering movement), posterior to anterior relative to the patient, in the y-plane.

The hip positioning system is configured for movement and ability to work with Trendelenburg tables and/or support tables that can pivot the pelvis upwards.

The hip positioning system is configured for movement with a biasing element, e.g., spring-loaded mechanism, to assist the surgeon with the weight of the limb and all with forms of movement.

The hip positioning system is configured for movement with a biasing element assisting in all degrees of movement, e.g., a coil spring, that has an open-design for easy cleaning and effective sterilization.

The hip positioning system is configured to be lightweight and compact for improved portability and sterilizability in conventional sterilizing systems.

The hip positioning system is configured to be lightweight and compact for easy storage, with few moving parts.

The hip positioning system is configured to reduce position error and is useful in various types of surgeries.

The hip positioning system is configured with a safety latch in between the pivot assembly and the extension assembly as well as between the ankle assembly and the extension assembly to protect against unwanted dislodging and improved safety in use.

The hip positioning system is configured with a gravity lock.

The hip positioning system is configured to position and/or can maintain patient and/or patient's limb above the sterile field.

The hip positioning system is configured to be lightweight and compact for frictionless transfer of movement via sliding friction plates and open stainless-steel roller bearings, each of which is sterilizeable and provides a simple cleanable construction.

The hip positioning system is configured with a boot that has open heel construction. The open heel construction provides and gives the surgeon the ability to measure the limb in the boot against the other leg when using the positioner so as to obtain proper leg length, e.g., by the ankle prominences (lateral malleolus, etc.) and/or the heel of the foot (e.g., calcaneus).

The hip positioning system is configured with a boot that includes a pivot block, which is a flexible attachment/connection that provides for semi-movement of, and freedom to operate of, the knee, to allow flexion for the knee, thus avoiding hyperextension of the knee and the patient's leg during a surgical procedure.

The hip positioning system is configured for maintaining positioning of the limb and the socket, thus reducing burdens and unneeded forces against joints.

### BRIEF DESCRIPTION OF THE DRAWINGS

FIG. 1 illustrates an apparatus, system, and method for performing a hip surgical procedure using a side rail of a support table;

FIG. 2 illustrates the pivot assembly for attaching to the clamp assembly attached to a side rail;

FIG. 3 illustrates the lifter assembly for attaching to the pivot assembly to lift the femur of the patient;

FIGS. 4A and 4B illustrate the extension assembly received in the pivot assembly;

FIG. 5 illustrates the ankle/lower limb assembly for securing to the extension assembly;

FIGS. 6A and 6B illustrate a perspective side view and expanded view of the limb assembly;

FIG. 7 illustrates a cross-sectional view of the extension assembly;

FIG. 8 illustrates a perspective view of a boot assembly thereof;

FIG. 9 illustrates a perspective view of a connector plate thereof;

FIG. 10 illustrates a perspective view of a connector block assembly thereof;

FIG. 11 illustrates a perspective view of a plunger thereof;

FIG. 12 illustrates a perspective view of a drive gear thereof;

FIG. 13 illustrates perspective view of a post thereof;

FIG. 14 illustrates a perspective view of a post thereof;

FIG. 15 illustrates a perspective view of a spring thereof;

FIG. 16 illustrates a perspective view of a thumb knob thereof;

FIG. 17 illustrates a perspective view of a biasing fastener assembly;

FIG. 18 illustrates a side view of a biasing fastener assembly;

FIG. 19 illustrates a perspective view of a biasing element;

FIG. 20 illustrates a side view of a biasing element;

FIG. 21 illustrates a perspective view of a knurled fastener;

FIGS. 22A and 22B illustrate a perspective side view and expanded view of wheel drive of the limb assembly according to another embodiment of the present invention;

FIG. 23 illustrates a base for the pivot assembly for securing the posts to the pin clamp assembly according to an alternative embodiment;

FIG. 24 illustrates a handle for the ankle assembly;

FIG. 25 illustrates a pin positioning plate for the handle of the ankle assembly;

FIG. 26 illustrates a bearing assembly for the handle of the ankle assembly;

FIG. 27 illustrates a dual locking assembly for the ankle assembly;

FIG. 28 illustrates a perspective view of the positioner system with a boot according to an alternative embodiment of the present invention;

FIGS. 29A-29F illustrate top, bottom, left side, right side, front and rear views, respectively, of the system of the present invention;

FIG. 30A illustrates a perspective side view;

FIG. 30B illustrates a perspective bottom view of an open heal of a boot assembly according to another embodiment of the present invention;

FIGS. 31A-31F illustrate rear, front, left side, right side, top, and bottom views, respectively, of the boot of the present invention; and

FIG. 32 illustrates a cross-section view of the surgical positioner assembly and system, illustrating a dual locking assembly for the ankle assembly.

### DESCRIPTION OF THE EMBODIMENTS

Non-limiting embodiments of the present invention will be described below with reference to the accompanying drawings, wherein like reference numerals represent like elements throughout. While the invention has been described in detail with respect to the preferred embodiments thereof, it will be appreciated that upon reading and understanding of the foregoing, certain variations to the preferred embodiments will become apparent, which variations are nonetheless within the spirit and scope of the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “some embodiments”, “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are provided for the purposes of illustrating some embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

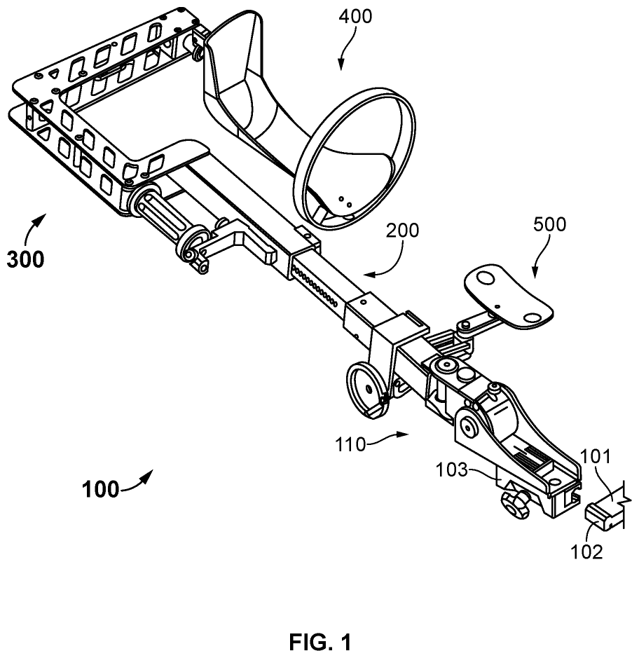

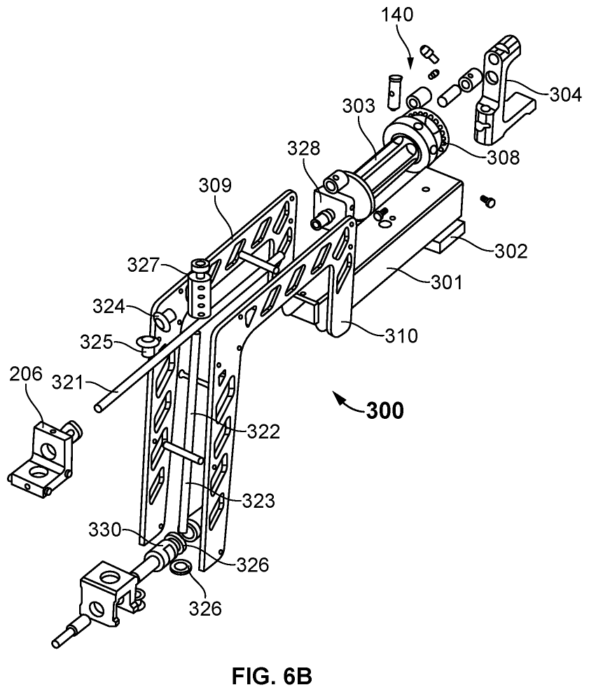

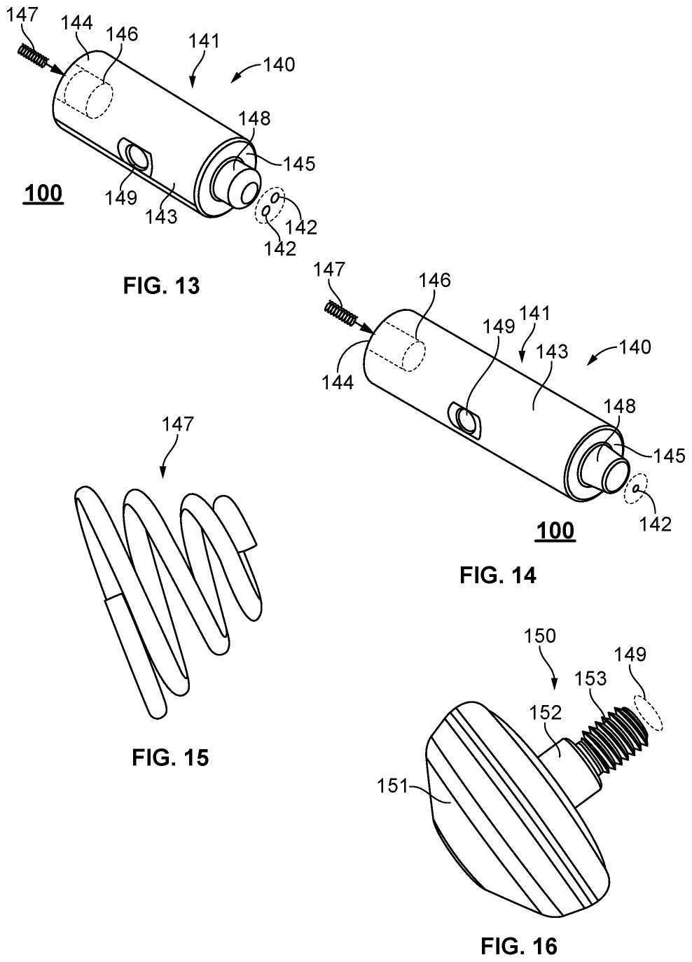

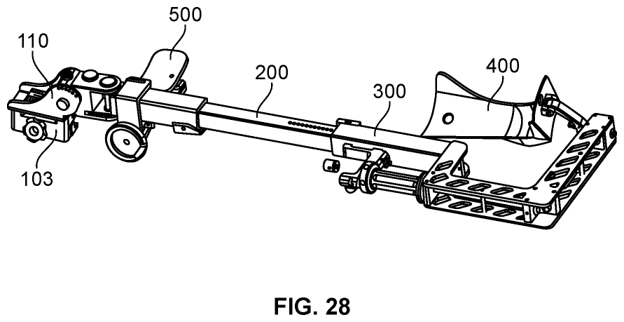

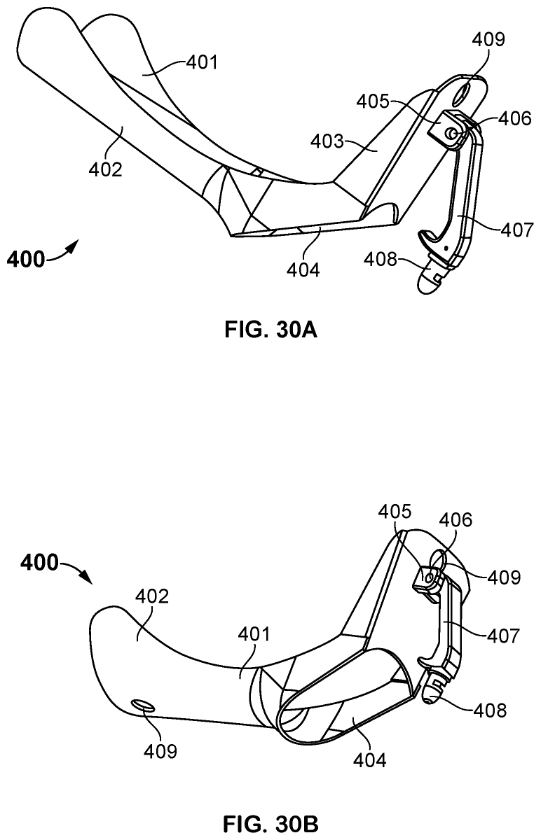

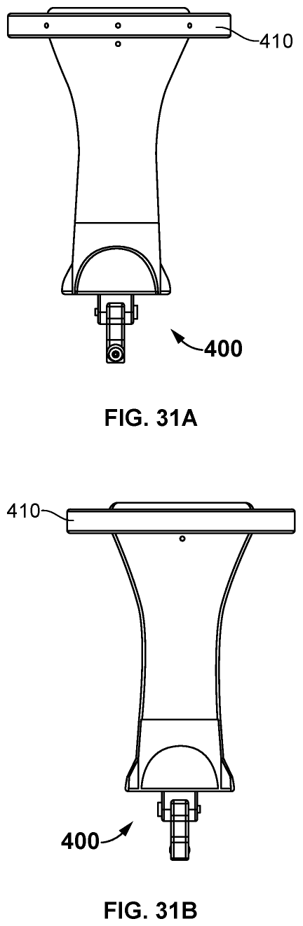

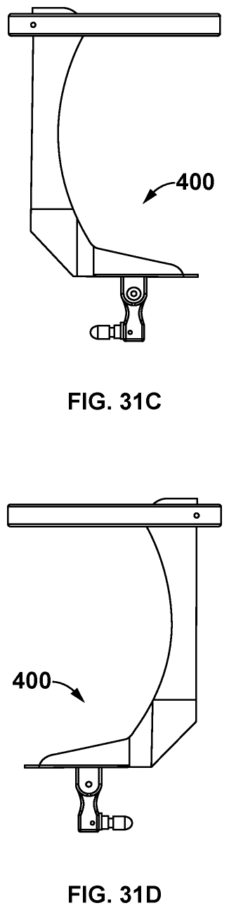

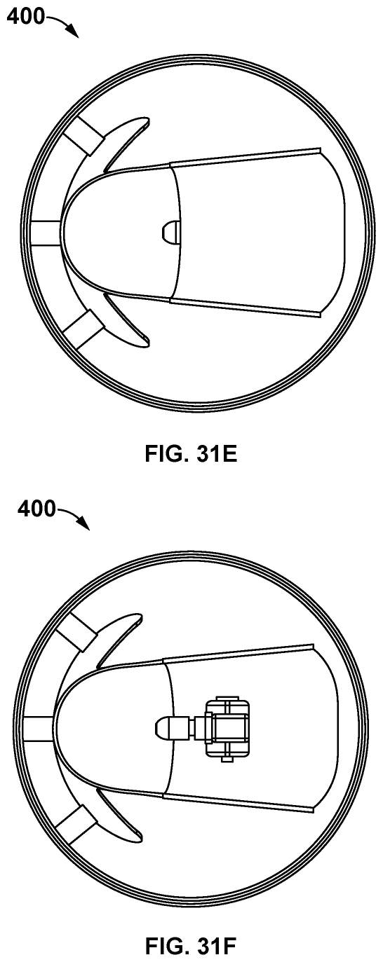

Referring to FIGS. 1-32 a surgical positioner apparatus, system and method generally designated as reference element 100 with motion from different force factors causing multiple components to move in a coordinated way. The surgical positioner 100 is useful in performing various surgical procedures when operably connected to a support table or operating room (OR) table 101 using the side rail 102 using a clamp 103 operably connected to the side rail. The surgical positioner apparatus, system and method 100 is for orthopedic procedures involving the positioning of a limb, and the distraction, dislocation, or replacement of a joint. The surgical positioner 100 is illustrated in the environment of a direct anterior hip replacement surgical procedure, which is a minimally invasive surgical technique involving a 3 to 4-inch incision on the front of the hip that allows the joint to be replaced by moving muscles aside along their natural tissue planes, without detaching any tendons. As should be appreciated, the environment is non-limiting as the surgical positioner apparatus, system and method 100 has further uses for other surgical procedures and applications.

The surgical positioner 100 is configured to be lightweight and compact for easy storage, and for simplified component parts, and is configured for use on either side rail 102 of a support table 101 or other bilateral attachment. The surgical positioner 100 has operably connectable subassemblies and/or components that comprise: a pivot clamp assembly 110, an extension assembly 200, an ankle assembly 300, and a boot assembly 400. A lifter assembly 500 can be operably connected to the arm of the pivot assembly 110 of the surgical positioner 100 and used to position the limb (e.g., femur) of the patient during surgical procedures.

### Pivot Assembly for Operably Connecting via Posts to a Clamp Assembly

As shown in FIGS. 1-2, 9-11, 13-21, 28-29F and 32, the pivot clamp assembly 110 comprises an enclosure 111 operably connected to a connector plate 160 on a distal end 110a and operably connected to a connector block assembly 180 on a proximal end 110brelative to the support table 101. The connector plate 160 operably connects one or more downwardly extending rods, posts and/or pins 168 configured to be received in corresponding openings in a clamp assembly 103 for securing to the rail 102 of the support table 101. A suitable clamp assembly is available under the brand Quad Clamp and is manufactured by Innovative Medical Products, Inc., Plainville, Conn.,

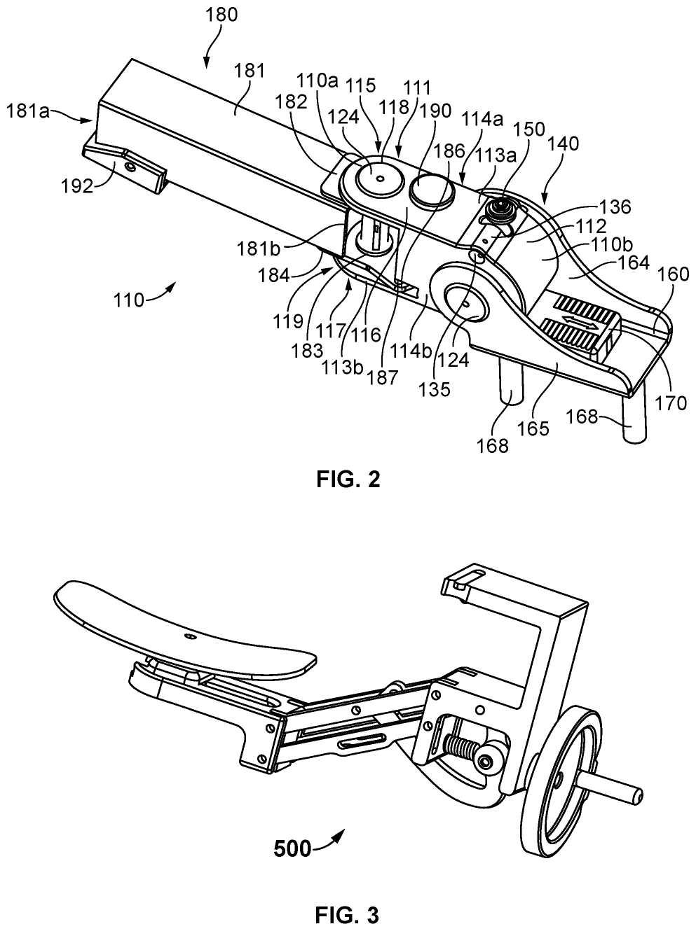

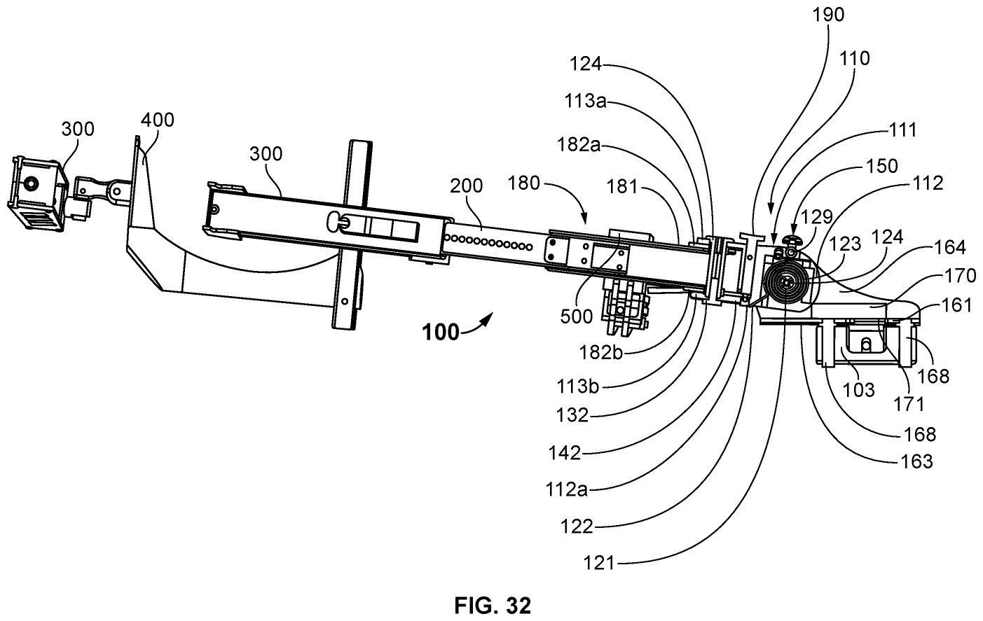

Referring to the pivot assembly 110 in FIGS. 2 and 32, the enclosure 111 generally comprises a housing 112 with upper and lower arms 113a and 113b extending distally from the housing 112 and side portions 114a and 114b. Each of the arms 113a, 113b has an opening for receiving and operably connecting the biasing element 120 comprising a first end 121, a second end 122 and a coil portion 123. The biasing assembly is configured to assist vertical movement of anything attached to the distal end of the pivot assembly 110. The enclosure 111 is configured to enclose the bias element 120 such as, for example, a coil spring 120 having a first end 121 secured by a biasing fastener assembly 124 in the housing 112 and a second end disposed to operably engage an edge 112a of the housing 112. The biasing fastener assembly 124 is adapted to operably connect the connector plate 160 to the enclosure 111 having the biasing element 120 disposed in the housing 112, for example, passing the biasing fastener assembly 124 through aligned opening 166a, openings in the side portions 114a, 114b, and terminating in opening 166b having a locking portion 167.

In operation, the pivot assembly 110 is operably connected to clamp assembly 103 and the rail 102 so as to move freely and rotatably in multiple directions in the coordinate x-, y- and z-planes, for example, in the x-plane motion using a biasing fastener element 124, in the y-plane motion using a pivot point formed by the connector block assembly 180 operably connected to enclosure 111 via the openings of the upper and lower arms 113a and 113b, and in the z-plane longitudinal motion using the telescopic adjoining sections of the body portion 181 and the extension assembly 200. For example, x-plane motion using a biasing fastener element 124 motion forming a pivot point rotatable therearound with a first end 121 disposed in the elongated shaft 129. It is appreciated that the pivot point can be formed in the housing 112 of the pivot assembly 110 either of the horizontal or vertical direction. The pivot assembly 110 can be configured with an upper portion 116 and a lower portion 117 forming supports for the pivot opening 115. The first end 121 of the biasing element 120 is secured in the slot 130 of the biasing fastener assembly 124 disposed between the arms 164, 165 of housing 112 through the aperture 166 and aligning with at least one lock 167 using the biasing fastener assembly 124. The second end 122 further is operably connected being disposed adjacent the edge 112a of housing 112. Biasing fastening assembly 124 and fastener 132 may be used as the pivot to connect via the arms 113a and 113b to the connector block 180.

### The Connector Block Assembly

As illustrated in FIGS. 2, 10, 13-14, 28-29F, and 32, the structure and operation of a connector block assembly 180 is described whereby the connector block assembly 180 is dimensioned to receive and operably connect to the extension assembly 200. The connector block assembly 180 includes a locking mechanism including a jaw assembly comprised of a cam arm pivotally attached at one end to the distal end 181a to maintain the connection to the extension assembly 200, e.g., to stop safely the sliding out of the extension assembly 200 such as, for example, forming a gravity lock. The connector block assembly 180 comprises a body portion 181 having a distal end 181a and proximal end 181b, an upper connector portion 182, and a lower connector portion 184. The proximal end 181b of connector block assembly 180 is configured to receive a biasing fastener assembly 124 aligned and disposed through openings 183a, 183b so as to operably connect the connector block assembly 180 to enclosure 111 via the openings of the upper and lower arms 113a and 113b. The body portion 181 may be configured as a sliding joint of a telescoped outrigger in a suitable shape and/or cross-sectional profile so as to mate adjoining sections of the body portion 181 and the extension assembly 200 thereby receiving and operably connecting the body portion 181 the extension assembly 200 thereby. The body portion 181 comprises an upper connector portion 182 and a lower connector portion 184 having a predetermined shape 185 with a positioning portion 186 and a plurality of openings 187 configured to mate and operably connect a post and/or protrusion 198 therein. For example, the plurality of openings 187 are arranged in an arc or other arcuate pattern to allow movement of the positioning connector block assembly 180 in angular positions of a lateral plane via locating the projection 198 in a respective opening 187, for example, as shown in FIGS. 10 and 11. The body portion 181 may further comprise a safety latch 190 with a jaw member 192 secured rotatably on the distal end 181a so that the jaw member 192 contacts an object in sliding relationship, for example, the rotating jaw member 192 and spacers 204 are urged together activating to firmly grasp the object.

The housing 112 has opening 115, which includes pivot post opening 118 configured to receive an upper portion 116 of the pivot post 115, and a pivot post opening 119 configured to receive the lower portion 117 of the pivot post 115 as shown in FIGS. 2, 10, and 32 (cross section view). The pivot post openings 118, 119 may be centrally disposed in the housing 112. The housing 112 therefore has an opening 115 for operably connecting a thumb control knob 150 to the connector plate 160 so as to allow movement in the lateral direction, e.g., x-axis.

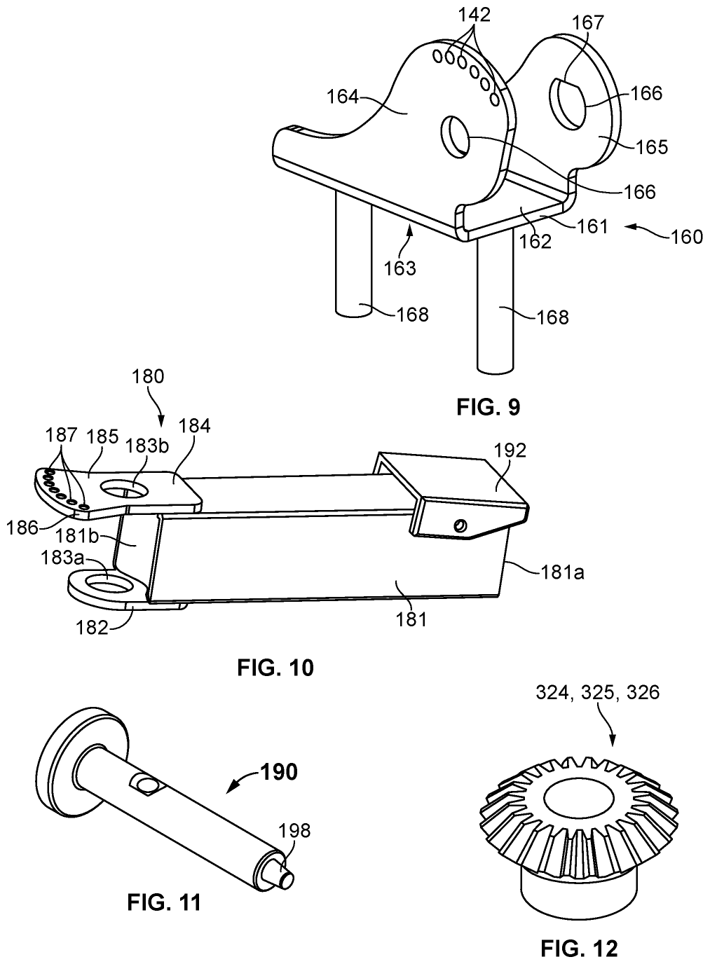

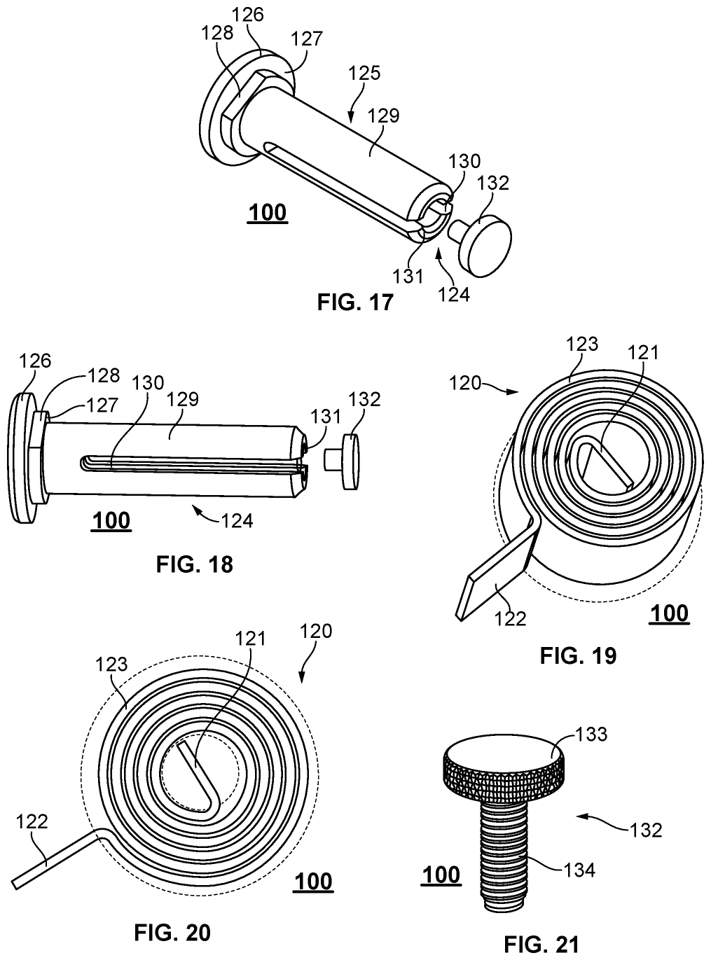

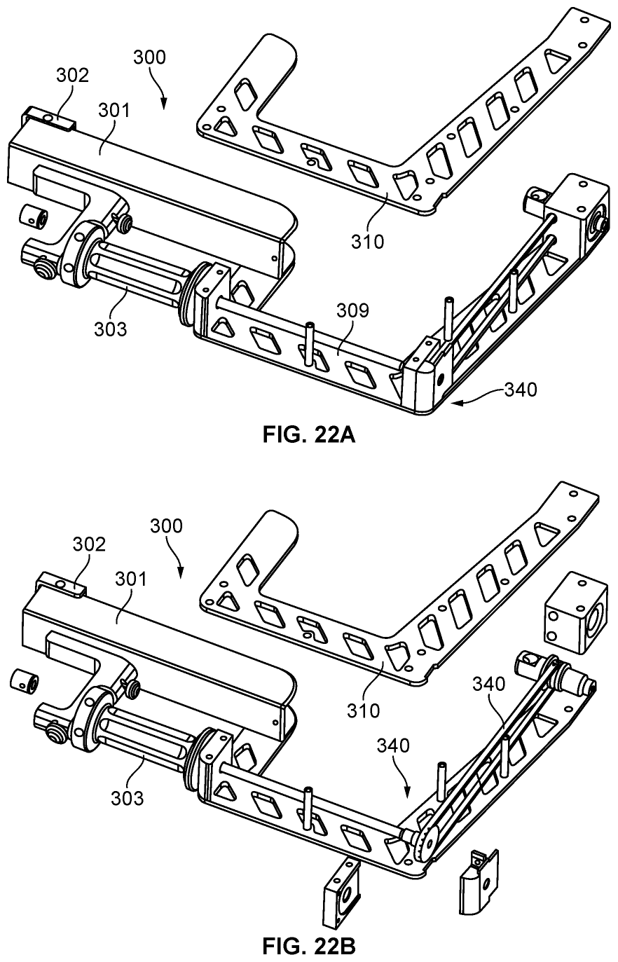

Referring to FIGS. 17-21, and 32, the biasing fastener assembly 124 includes a post 125 having a head 126 at one end and a recess 127 with a rotation locking portion 128 for locking into a locking portion 167 as shown in FIG. 9, of the connector assembly 160, and to fix second end 122 within the enclosure 111, thereby allowing the biasing element 120 to rotate around the elongated shaft 129. The elongated shaft 129 has a slot 130 extending from the opposite end partially towards the first end for receiving the first end 121 of the biasing element 120. As shown in FIGS. 17-21 and 32, the shaft 129 at the opposite end includes an opening 131 that may be threaded and adapted to receive another fastener 132. As illustrated in FIG. 21, the fastener 132 comprises a knurled head 133 and a threaded shaft 134 for fastening the coil portion 123 within the enclosure 111.

The second end 122 of the biasing element 120 rests on an edge of the housing 112 to provide the biasing force to the pivot assembly 110 as shown in FIG. 32.

The housing 112 of the pivot assembly 110 further comprises an opening 135 for a control assembly 140 as shown in FIGS. 1, 2, 13-16, and 32. The opening 135 may further include pinholes 136 to set the spring 147 and otherwise to provide for increased sterilization and flushing. The control assembly 140 is used throughout the invention to position a pin 141 in adjoining openings 142 for linear and/or angular positions as shown in FIGS. 1, 4A-4B, 23, 25, 29A-29F, and 32. Each control assembly 140 comprises a shaft 143, first end 144, second end 145, wherein the first end 144 can have a recess 146 adapted to receive a straight spring 147 to allow assisted biased manipulation by the thumb of a user. The second end 145 can be configured with the protrusion 148 to engage the openings 142. An additional opening 149 at the midpoint of the shaft 143 is adapted to receive the thumb control knob 150. The thumb control knob 150 comprises a head 151 at one end and a shaft 152 extending therefrom having a threaded portion 153 for engaging the opening 149, formed as a path through an L-shaped slot formed in the enclosure 111 as well as other components of the apparatus 100, such as L-shaped slots in the ankle assembly 300. In operation, the user can push the thumb control knob 150 between the ends of the L-shape slot to engage and disengage the protrusion 148 from any of the openings 142. The protrusion 148 can be used for disengaging to allow movement in the vertical direction and then setting in the desired positioned by engaging the protrusion 148 in a corresponding opening 142.

### Connector Plate

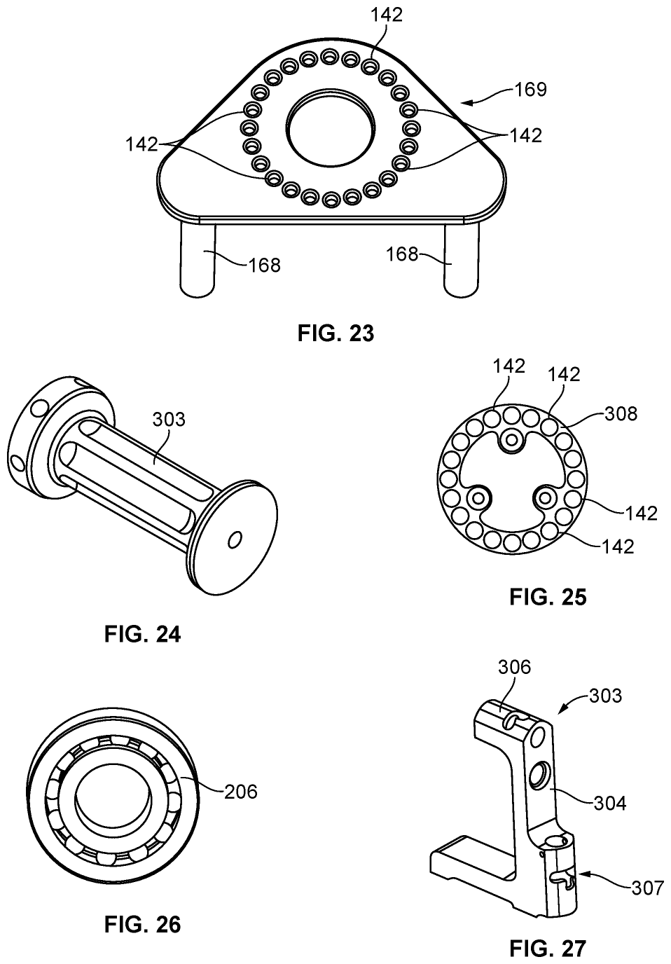

According to an embodiment of the present invention as shown in FIGS. 2 and 9, connector plate 160 comprises a base 161 having an upper portion 162 and a lower portion 163. The base can be formed in a generally planar shape, the base 161 a may be formed from metals and metal alloys such as, for example, a plate of suitable dimension, strength, and material that can be sterilized. Base 161 may have upward extending arms 164, 165, each having an opening 166a and 166b, respectively, disposed near to the center portion thereof, with one opening having a locking portion 167 for engaging the locking portion 128 to maintain the biasing fastener 124 in a fixed position from rotation from forces of the biasing element 120. The arm 164 of the base 161 may have a plurality of protrusion openings for locating and adjusting position, for registering the protrusion 148 therein. Lower portion 163 has one or more posts 168 to engage openings in the clamp assembly 103, operably connected to the side rail 102 of a support table and/or OR table 101. Alternatively, an alternative connector plate 169 may be formed as shown in FIG. 23 for disposing the pivot assembly 90 degrees relative to the clamp assembly 103.

### Spring Control Block

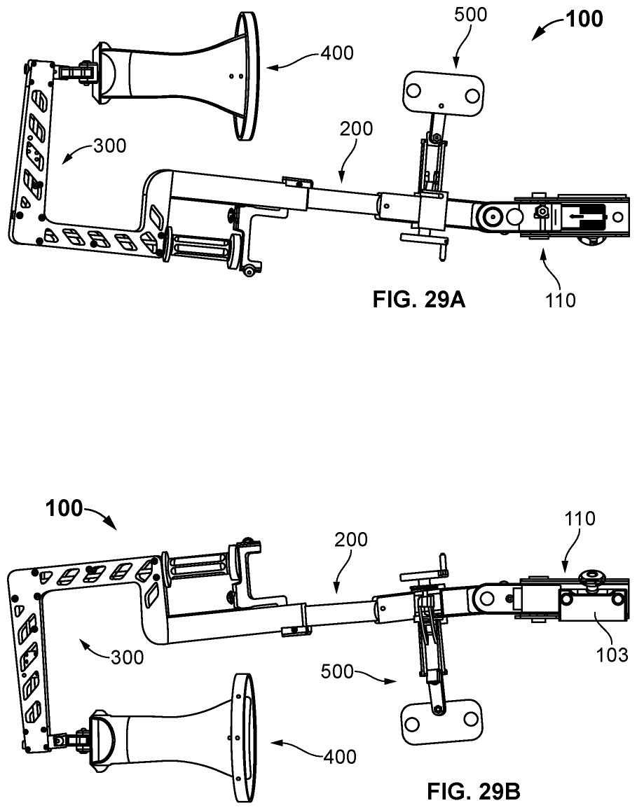

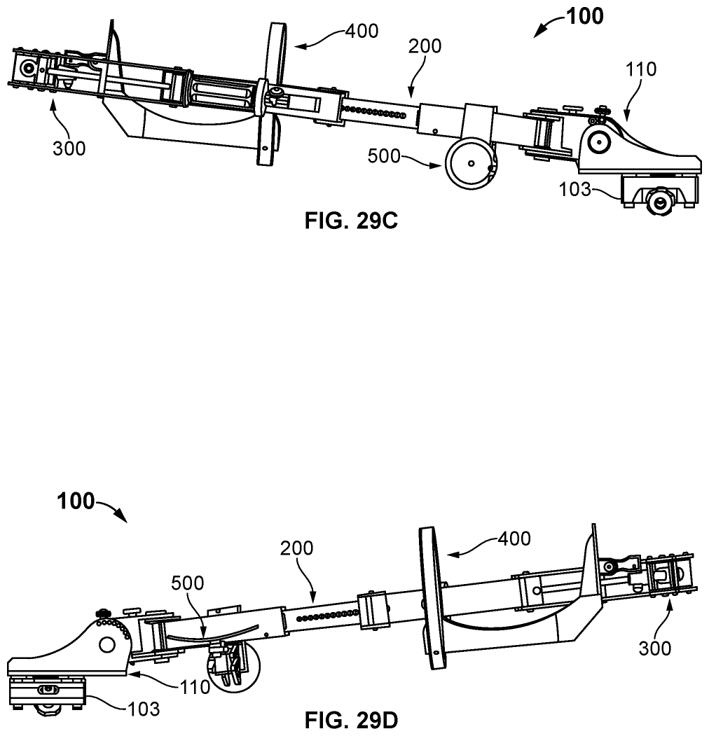

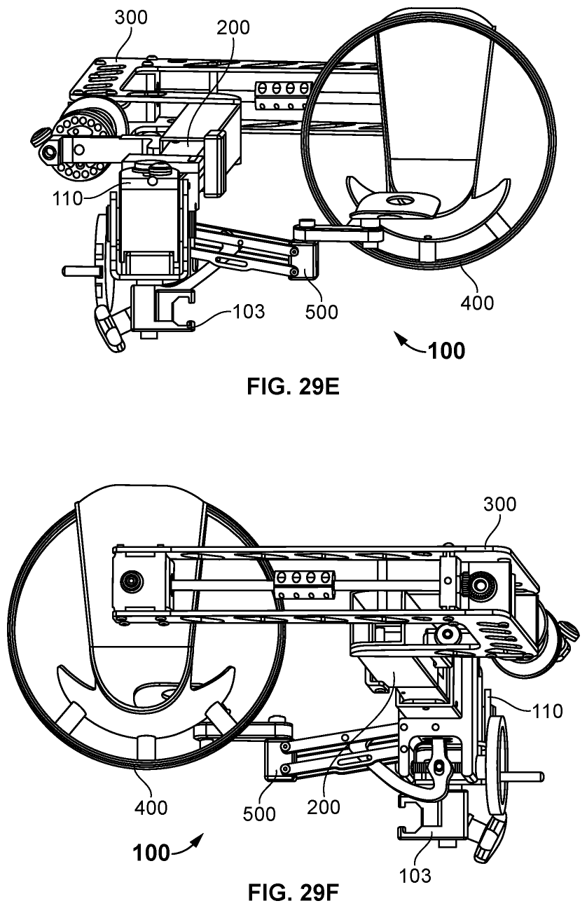

As shown in FIGS. 2, 29A and 32, a spring control block 170 forms a stop for the pivot damp assembly 110 when biased by the biasing element 120. The spring control block 170 can be pushed underneath the enclosure 111 and/or housing 112 by sliding with the users thumb, whereby the base 161 of the connector plate 160 can have a slot 171 for the travel of the spring control block 170 as shown in FIG. 29. The spring control block 170 provides safety to the user.

As shown in FIGS. 1, 2, 10, 29A-29F, and 32, a connector block assembly 180 comprises an elongated body 181 having a proximal end 181b and distal end 181a relative to the support table 101. The proximal end 181b can attach by a fastener and/or a friction bearing 182 to the pivot assembly 110 and the distal end 181a can have a jaw member 192 configured to be operably connected and secured to the proximal end 202 of the extension assembly 200, through aligned openings in each of the side portions of the connector 180 and extension assembly 200.

The connector 180 body has a dimension to receive a proximal end 202 of an extension assembly 200 therein. The body 181 may be formed in any cross-section, such as, for example, box section, circular, oval, rectangular, multi-hollow shapes, extruded shapes, and other shapes formed from suitable materials such as, for example, metals and metal alloys, stainless steel, aluminum 6061, 6063, and 3003 that can accept coatings, such as anodize or chem-film, are compliant with sterilization protocols, and which are biocompatible. According to an embodiment of the present invention, a square tube 205 may be used that is commonly available in Aluminum, Stainless Steel, Hot Rolled Steel and Cold Rolled Steel and that can be cut to exact specifications. Side portions 202 may be secured to the body 201, wherein each of the side portions has a first portion for securing to the proximal end section of the body, and a second portion disposed opposite the first portion, the second portion configured with a plurality of holes for registering the pin post of the thumb grip assembly. Furthermore, openings may be disposed in each side portion 202, where one of the openings may have a locking segment for operably engaging a corresponding locking segment on the biasing fastener assembly 124, so as to secure and hold the biasing element.

### Biasing Element (Spring) Assembly

Referring to FIGS. 19 and 20, biasing element (spring) assembly 120 comprises: a biasing element that can be formed from a coil of ribbon stock of metal, for example, steel, stainless steel, heat treated steel, and the like an end portion 121 located at a center of the coil, bisecting the circular coil, configured to operably receive and connect to a biasing fastener assembly 124, specifically, by conforming to a circular dimension, as shown in FIGS. 17-18, and a second end portion 122, forming a flange disposed at an angle, so as to operatively engage the end 112a of the housing 112, The biasing element 120 is operably connected in the assembly 110 by biasing fastener assembly 124 and the fastening element 132.

### Biasing Fastener Assembly

Referring to FIGS. 17-18 and 32, each biasing fastener assembly 124 comprises: a first end fastener comprising knurled knob 126, a post 129 secured to the knurled knob 126, post 129 configured with a slot 130 extending along a portion thereof, and terminating before the knurled knob 126, slot is 130 configured to receive the end portion 121 of biasing element 120 in center of coil, second end fastener 132 with knurled knob 133 and threaded portion 134 for operably connecting to post member, e.g. threads, the first end 126 has a recess 127 and locking portion adjacent the elongated shaft 129 so as to connect to openings, such as for example, opening 16 to engage with locking portion 167.

### An Extension Assembly

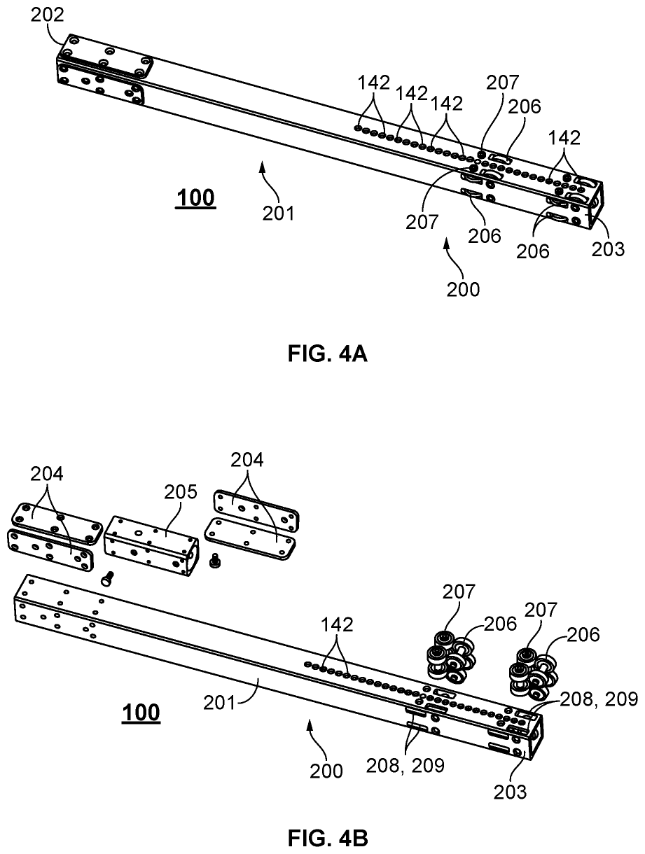

Referring to FIGS. 1, 4A-4B, 28-29F, and 32, an extension assembly 200 comprises a body 201, the body being formed with a proximal end 202 and distal end 203 relative to the support table. The body 201 has a dimension to insert the proximal end 202 into the connector block assembly 180 and the distal end 203 into the connector body 301 of the ankle assembly 300. The body 201 may be formed in any cross-section such as, for example, box section, circular, oval, rectangular, multi-hollow shapes, extruded shapes, and other shapes from suitable materials such as, for example, metals and metal alloys, stainless steel, aluminum 6061, 6063, and 3003 that can accept coatings, such as anodize or chem-film, are compliant with sterilization protocols, and are biocompatible. According to an embodiment of the present invention, a square tube may be used that is commonly available in Aluminum , Stainless Steel, Hot Rolled Steel and Cold Rolled Steel, and that can be cut to exact specifications. According to an alternative embodiment of the invention, the body 201 and proximal end 202 comprise one or more friction reducing spacers 204 secured to the proximal end 202 of the extension assembly 200 by fasteners having a profile which does not impede insertion. For example, in a tubular shape, a single friction reducing spacer may be formed in inner collar 205 disposed on the proximal end 202 for creating additional structural support. The distal end 203 of the extension assembly 200 can be configured with one or more roller assemblies or bearings 206, shown in FIG. 26, that may be operably connected and secured to the distal end 203 by fasteners 207 extending through aligned openings 208 and extending out of slots 209 in each of the side portions of extension assembly 200 as shown in FIGS. 4A and 4B. The distal end may be configured with openings for fasteners, roller assemblies, and holes for the protrusion 136 along the length thereof. One or more roller assemblies can be disposed in slot openings formed in the distal end of the extension assembly. The roller assemblies comprise a shaft dimension to receive a roller and ends having openings configured to receive fasteners therein. The fastener openings 208 can be configured 10 be aligned with the shaft of the roller assemblies so as to secure to the shaft having the roller assemblies protruding from the slot openings in the extension assembly. At least one side portion comprises pin post openings dimension to receive the pin post from the lower limb assembly.

### The Ankle Assembly

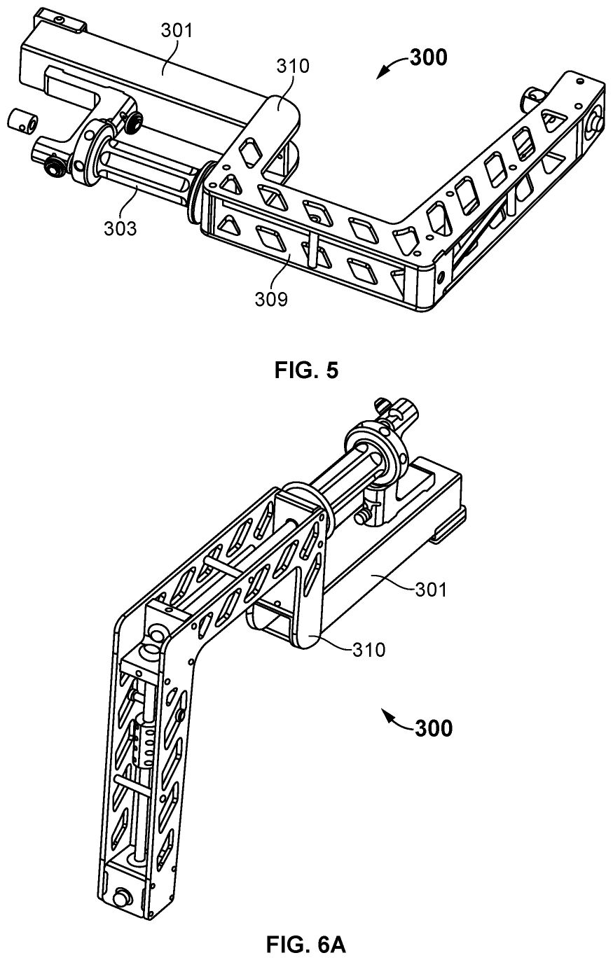

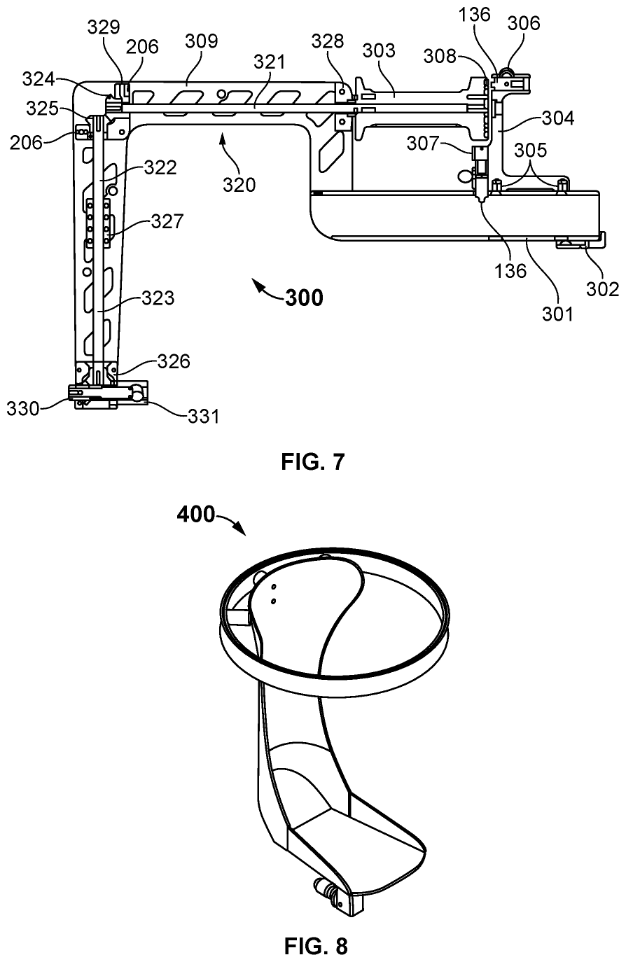

As shown in FIGS. 1, 5, 6A-6B, the cross-sectional view of FIG. 7, as well as FIGS. 22A-29F and 32, the ankle assembly 300 comprises a connector body 301 having a safety catch/latch 302 for attaching to the extension assembly 200. The ankle assembly includes a handle 303 disposed on a base 304 attached to the connector body 301 by suitable fasteners 305. The base 304 has a control assembly 306 and 307, using the structures of the control assembly 140. The control assembly 307 is used to set the extension assembly 200 within the base 301 at a desired length for the patient's limb. The control assembly 306 is used to set the angular displacement of the handle through the control holes of the plate 308 as shown in FIG. 21. Two plates 309 and 310 house a drive system 320 for rotating the boot assembly 400 using the handle 303. The plates 309 and 310 may be secured together by spacers or other means, e.g., extruded construction, that is sterilizable and allows for cleaning and weight reduction. The drive system 320 includes shafts 321, 322, 323 having gears 324, 325 and 326 secured to the ends thereof. The shafts 322 and 323 may be joined by a union 327 so as to adjust and set the gears 324, 325 and 326. The drive system may further include gearboxes 328, 329 and 330 that can house a plurality of sterilizer and cleanable roller bearings 206. The gear 328, 329 and 330 adjust by the handle 303 and via the swivel post 331 that attaches to the boot assembly 400. Alternatively, a belt drive system 340 may be used to turn the swivel post as shown in FIGS. 5, 22A and 22B.

### The Boot Assembly

As shown in FIGS. 1, 8, 29A-29F, 30A-30B and 31A-31F, and 32, the boot assembly 400 includes a body 401 having a calf portion 402 and a foot bed 403 with an open heel 404. The foot bed 403 comprises a pivot block 405 which accepts a pin 406 that is disposed through a connection arm 407 having an anchor post 408. The connector arm 407 attached to the pivot block 405 is flexible around the pivot so as to allow the limb of the patient to be set in a non-hyperextended position when being manipulated. A simple pull pin allows for release of the boot for easy range of motion (ROM) testing. The calf portion 402 and foot bed 403 can further comprise openings 409 useful to attach a boot pad thereto. One or more openings 409 in the calf portion 402 and foot bed 403 provide for securing a tab of a protector pad thereto so as to secure in a predetermined position. The open heel 404 provides access to the patient's limb for the surgical procedure. Additionally, the boot 400 may comprise a ring 410 operably connected to the calf portion 402, and, in operation, a patient's limb and foot may be placed within the ring 410 to prepare for the surgical procedure and the ring 410 may be utilized for further assisting angular adjustments via the handle 303 such as grasping by the surgeon to create sufficient force to separate the hip bone from the joint in direct anterior approach surgical hip replacement surgery.

While certain configurations of structures have been illustrated for the purposes of presenting the basic structures of the present invention, one of ordinary skill in the art will appreciate that other variations are possible which would still fall within the scope of the appended claims. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A hip positioning system for a support table having a side rail, the hip positioning system comprising:
a pivot assembly for attaching to the side rail, said pivot assembly comprising a fastener assembly forming a pivot for the x-direction of an x-plane, a biasing fastener assembly forming a second pivot for the y-direction of a y-plane, and a biasing element and a locking assembly for fixing controlling movement of said pivot assembly in the x- and y-plane;
an extension assembly providing sliding movement in the z-direction of a z-plane, said extension assembly being dimensioned to be operably connected to said pivot assembly;
a rotational assembly comprising a portion for operably connecting to said extension, a device attachment portion, and said rotational assembly operably connected to said device attachment portion for providing rotational thereof; and
a boot comprising body having a calf portion, a foot bed, and an open heel, said foot bed comprises a pivot block configured to accept a pin that is disposed through a connection arm having an anchor post, said connector arm being configured to operably connect flexibly to said pivot block forming a flexible attachment, between said boot and said device attachment portion.

2. A hip positioner system for a support table having a side rail, the hip positioning system comprising:
a pivot clamp assembly including a connector plate operably coupled to the side rail, an enclosure having a proximal end pivotably coupled to said connector plate forming a first pivot, said enclosure further including a distal end, said pivot clamp assembly further including a block assembly having a body portion, a proximal block end pivotably coupled to said distal end of said enclosure forming a second pivot and a distal block end, wherein said first pivot provides vertical, y-plane, adjustment of said hip positioner system relative to the support table, and said second pivot provides horizontal, x-plane, adjustment of said hip positioner system relative to the support table;
an extension assembly, disposed on the distal block end of said block assembly at a first end, a second end, and an extension body disposed therebetween;
an ankle assembly including a first portion, for operably coupling to said second end of said extension assembly, a second portion, and first and second control assemblies; and
a boot assembly including a boot body having a calf portion and a foot bed having a pivot block operably coupled to said second portion of said ankle assembly, said calf portion and said foot bed configured to hold the limb of a patient, wherein said first control assembly of said ankle assembly provides extension, z-plane, adjustment of said hip positioner through discrete positioning of said ankle assembly relative to said extension assembly, and wherein said second control assembly of said ankle assembly provides rotational, x-axis, adjustment of said boot assembly through discrete positioning of said pivot block relative to said second portion of said ankle assembly.

3. The hip positioner system of claim 2, wherein said first pivot further comprises a biasing fastener assembly disposed on said connector assembly and operably coupled to a biasing element for assisting the surgeon with the weight of the patient's limb when conducting movements.

4. The hip positioner system of claim 3, wherein said biasing element is a flat torsion spring.

5. The hip positioner system of claim 2, wherein said connector assembly further comprises a first arm having a plurality of radially-arrayed openings configured to receive a protrusion of a control assembly, said protrusion of said control assembly being operatively manipulable to provide discrete, y-plane, positioning and/or adjustment of said hip positioner relative to the support table.

6. The hip positioner system of claim 5, wherein said control assembly further comprises a pin body having a first and second pin end, wherein said protrusion extends outwardly from said second pin end and said pin body further includes a thumb control knob, said first pin end comprising a spring to allows assisted biased manipulation by the thumb of the user via said thumb control knob.

7. The hip positioner system of claim 2 further comprising a lifter assembly operably coupled to said body portion of said block assembly, for positioning the limb of a patient.

8. The hip positioner system of claim 2, wherein said second control assembly of said ankle assembly further comprises a handle and a drive system comprising a plurality of rotatable shafts including gears disposed on either end of said rotatable shafts, said handle configured to allow the user to impart rotational movement transferred through said drive system to said boot assembly.

9. The hip positioner system of claim 2, wherein said second control assembly of said ankle assembly further comprises a handle and a belt drive system comprising a plurality of belts disposed on a plurality of rotatable elements, said handle configured to allow the user to impart rotational movement transferred through said belt drive system to said boot assembly.

10. The hip positioner system of claim 2, wherein said boot assembly further comprising a ring circumferentially disposed on said calf portion, said ring configured to assist the user with angular and/or rotational adjustments of said boot assembly.

11. A method for performing a DAA hip surgical adjustment using a surgical table having a side rail, the method comprising:
attaching a pivot assembly to the side rail at a proximal end of said pivot assembly, said pivot assembly having a distal end configured for movement in the x-plane and y-plane;
attaching a proximal end of an extension assembly to said distal end of said clamp assembly, said extension assembly having a distal end configured for longitudinal movement therealong;
attaching a proximal end of a rotational assembly to said distal end of said extension assembly; and
attaching a boot to a distal end of said rotational assembly.

12. the method of claim 11, comprising the further step of: attaching a lifter assembly to the pivot assembly for supporting a femur of the patient.
